(19) United States
(12) Patent Application Publication
(10) Pub. No.: US 2026/0341689 A1
(43) Pub. Date: Oct. 29, 2026

(54) SILICON-BASED ANODE MATERIAL, ANODE STRUCTURE FOR LITHIUM-ION BATTERIES, AND LITHIUM-ION BATTERY

(71) Applicant: GIGA SOLAR MATERIALS CORPORATION, Hukou Township (TW)

(72) Inventors: Ding-Jhou WU, Hukou Township (TW); Ning LEE, Hukou Township (TW); Cheng-Yang LIU, Hukou Township (TW)

(73) Assignee: GIGA SOLAR MATERIALS CORPORATION, Hukou Township (TW)

(21) Appl. No.: 19/466,965

(22) Filed: Feb. 2, 2026

(30) Foreign Application Priority Data
Apr. 24, 2025 (TW) 114115469

(51) Int. Cl. H01M 4/38; H01M 4/02; H01M 4/134; H01M 4/36; H01M 4/583; H01M 10/0525

(52) U.S. Cl. CPC H01M 4/386; H01M 4/134; H01M 4/366; H01M 4/583; H01M 10/0525; H01M 2004/021; H01M 2004/027

(57) ABSTRACT

A silicon-based anode material, an anode structure for lithium-ion batteries, and a lithium-ion battery are provided. The material includes a non-metal-doped silicon carbon particle and an aluminum oxide coating layer. The silicon carbon particle is composed of a mixture of SiOₓ and carbon, where 0≤x<1, and a surface thereof is coated with the aluminum oxide coating layer. In the Raman spectrum of the material, a ratio of characteristic peak areas of aluminum oxide to that of silicon is greater than 1.2%. The aluminum oxide coating layer provides excellent water resistance, thereby improving the capacity stability of the lithium-ion battery. In addition, the aluminum oxide coating layer can effectively protect the silicon carbon particle, reduce corrosion by the electrolyte, and significantly improve the cycle life of the silicon-based anode material, while effectively suppressing volume expansion and improving the overall performance of the battery.

This application claims the priority benefits of Taiwan Patent Application No. 114115469, filed on Apr. 24, 2025. The entirety of each of the above-mentioned patent applications is hereby incorporated by reference herein and made a part of this specification.

### BACKGROUND OF THE INVENTION

### Field of the Invention

The invention relates to the technical field of lithium-ion batteries, in particular, to a silicon-based anode material, an anode structure for lithium-ion batteries, and a lithium-ion battery.

### Description of the Prior Art

With the widespread application of lithium-ion batteries in consumer electronics, electric vehicles, and energy storage systems, the development of high-capacity anode materials has become crucial for improving battery performance. Silicon-based anode materials are considered an ideal choice for next-generation high-energy-density batteries due to their theoretical specific capacity of up to about 4200 mAh/g, far exceeding that of traditional graphite anodes (about 372 mAh/g).

However, the silicon-based anode materials still face many technical challenges. First, silicon undergoes volume expansion of up to 300% or more during insertion and extraction of lithium ions, leading to material structure cracking, electrode delamination, and damage to the conductive network, which in turn affects the cycle life of the battery. Secondly, when silicon surfaces come into contact with electrolytes, side reactions are prone to occur, forming an excessively thick or unstable solid electrolyte interphase (SEI) layer, which leads to irreversible loss of lithium ions, increases internal resistance and reduces coulombic efficiency. In addition, silicon itself has low conductivity, which is not conducive to electron transport and affects the rate performance and fast charging capability of the battery.

In order to solve the above problems, various improvement strategies have been developed in the prior art, such as using carbon materials to coat silicon particles to improve conductivity, or introducing nanostructures and porous structures to alleviate volume expansion. However, existing carbon coating technology still faces the problem of uneven coating, leading to some silicon surface being exposed, which can then react with trace amounts of water in the battery to produce gas to affect the stability of the SEI layer and shorten the battery life. Therefore, how to achieve a uniform and stable coating structure while improving the conductivity and mechanical stability of the material remains a core issue in the development of silicon-based anode materials.

### BRIEF SUMMARY OF THE INVENTION

In view of the above problems, a main objective of the invention is to provide a silicon-based anode material, an anode structure for lithium-ion batteries, and a lithium-ion battery, which utilizes an aluminum oxide coating to improve water resistance and structural stability, thereby improving the cycle life of the battery.

To achieve the above objective, the invention provides a silicon-based anode material, which includes a non-metal-doped silicon carbon particle and an aluminum oxide coating layer. The silicon carbon particle has a composition of a mixture of SiOₓ and carbon, wherein 0≤x<1; the aluminum oxide coating layer is coated onto a surface of the silicon carbon particle, and in the Raman spectrum of the silicon-based anode material, a ratio of characteristic peak areas of aluminum oxide to that of silicon is greater than 1.2%.

According to an embodiment of the invention, a median particle size (D50) of the silicon carbon particle is between 1 and 15 micrometers.

According to an embodiment of the invention, a composition of the aluminum oxide coating layer includes one or more of aluminum oxide (Al₂O₃), aluminum hydroxide (Al(OH)₃), aluminum sulfate (Al₂(SO₄)₃), aluminum phosphate (AlPO₄), aluminum tripolyphosphate, aluminum borate (AlBO₂), and aluminum silicate (Al₂SiO₅).

On the other hand, the invention further provides a lithium-ion battery anode structure, which includes the above silicon-based anode material, and an adhesive, a conductive agent and copper foil, wherein the silicon-based anode material, the adhesive, and the conductive agent are uniformly mixed to form a slurry, which is then coated onto a surface of the copper foil and dried and compacted to form a stable anode material layer.

Still further, the invention provides a lithium-ion battery, which includes a cathode, an anode, a separator film, and an electrolyte, wherein the anode adopts the above lithium-ion battery anode structure, the cathode and the anode are respectively disposed inside the lithium-ion battery and separated from each other by the separator film, and the electrolyte is immersed among the cathode, the anode and the separator film.

Compared with the prior art, the silicon-based anode material and an application thereof in lithium-ion batteries provided by the invention utilize the aluminum oxide coating layer to effectively protect the silicon carbon particle, prevent the silicon surface from being exposed and from being reacted with the electrolyte or trace amounts of moisture, thereby reducing gas generation and improving the stability of the SEI layer. Moreover, the aluminum oxide coating layer provides excellent waterproofing, improves the capacity stability of lithium-ion batteries, effectively improves the cycle life of batteries under high temperature, reduces the volume expansion of silicon-based anode materials, and thus improves the overall performance and reliability of lithium-ion batteries.

The following detailed description is further made by the inventor through specific embodiments in conjunction with the attached drawings, so that the purpose, technical content, characteristics and effects achieved by the invention can be more easily understood.

### BRIEF DESCRIPTION OF THE DRAWINGS

FIG. 1 is a diagram of a silicon-based anode material provided by an embodiment of the invention.

FIG. 2 is a diagram of an anode structure of a lithium-ion battery provided by an embodiment of the invention.

FIG. 3 is a diagram of the lithium-ion battery provided an embodiment of the invention.

FIG. 4 shows the Raman scattering spectra of the silicon-based anode material of an embodiment and a comparative example of the invention.

FIG. 5 shows the relationship between the intensity of the aluminum characteristic peak and the etching depth obtained by surface XPS analysis for the silicon-based anode material of the invention.

FIG. 6 shows the relationship of changes in gas production over time of a slurry prepared from the silicon-based anode material in an embodiment and a comparative example of the invention.

### DETAILED DESCRIPTION OF THE INVENTION

The technical solutions used in the embodiments of the invention are for the purpose of more clearly illustrating the technical solutions of the invention, and are therefore only examples. Unless otherwise specified, they should not be used to limit the scope of protection of the invention. In order to give the reader a more complete understanding of the invention, many specific details are provided in the description of the specification; however, the invention may still be practiced even if some or all of the specific details are omitted. Furthermore, well-known steps or elements are not described in detail to avoid creating unnecessary limitations on the invention. In the case of no conflicts, the embodiments and features in the embodiments of the disclosure can be combined mutually. It should be noted that, unless otherwise specified, all technical and scientific terms used in the invention have the same meaning as commonly understood by those skilled in the art to which the invention pertains.

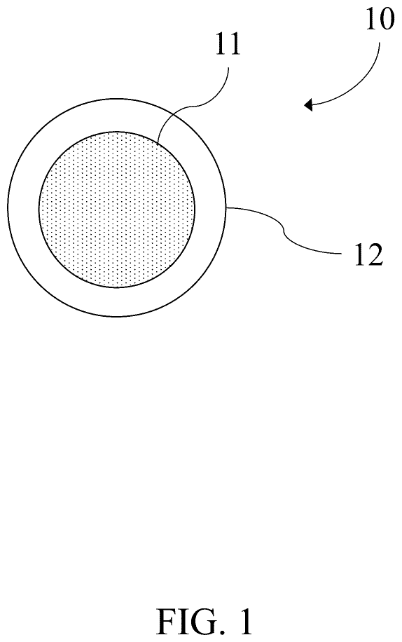

With reference to FIG. 1, a diagram of a silicon-based anode material provided by an embodiment of the invention is shown. The silicon-based anode material 10 of the embodiment includes a non-metal-doped silicon carbon particle 11 and an aluminum oxide coating layer 12.

The non-metal-doped silicon carbon particle 11, as a core of the silicon-based anode material 10, has a composition of a mixture of SiOₓ and carbon, wherein 0≤x<1. The proportion of SiOₓ in silicon carbon particle is between 40% and 60%. Further, a median particle size (D50) of the silicon carbon particle 11 is preferably between 1 and 15 micrometers.

The aluminum oxide coating layer 12 is coated on a surface of the silicon carbon particle 11 to form an outer layer of the silicon-based anode material 10. The aluminum oxide coating layer 12 provides uniform coatings to ensure that all silicon carbon particles 11 are uniformly protected by the aluminum oxide coating layer 12. Further, in the Raman spectrum of the silicon-based anode material 10, a ratio of characteristic peak areas of aluminum oxide to that of silicon is greater than 1.2%. Further, a composition of the aluminum oxide coating layer 12 includes, but is not limited to, one or more of aluminum oxide, aluminum hydroxide, aluminum sulfate, aluminum phosphate, aluminum tripolyphosphate, aluminum borate, and aluminum silicate.

In the invention, through the aluminum oxide coating layer 12, the stability of the silicon-based anode material 10 may be effectively improved, and complete waterproofing is provided to prevent the silicon carbon particle 11 from being reacted with trace amounts of moisture in the lithium-ion battery, thereby reducing gas generation. Moreover, the aluminum oxide coating layer 12 may effectively block the electrolyte from corroding the silicon carbon particle 11, reduce the unstable formation of the SEI layer, and further improve the cycle life of the lithium-ion battery. Meanwhile, the uniform coverage of the aluminum oxide coating layer 12 helps to mitigate the volume expansion of the silicon carbon particle 11 during charging and discharging, enabling the lithium-ion battery to maintain stable capacity retention and excellent safety under high temperature and long-term use conditions.

The silicon-based anode material 10 of the invention may be prepared by the following method, which includes the following steps.

First, a silicon bulk material with a purity higher than 99.995% is used as the raw material, with a composition including SiOₓ (0≤x<1) and carbon, and is mechanically ground into a powder with a particle size of less than 150 nanometers. Subsequently, through a granulation process, a silicon carbon particle with a median particle size (D50) between 5 and 10 micrometers is formed. Then, aluminum nitrate is dissolved in alcohol to prepare an aluminum nitrate solution with a weight percentage concentration greater than 0.1%, and the silicon carbon particle is placed in the aluminum nitrate solution for more than 1 hour for aluminum nitrate pretreatment. Next, the silicon carbon particle impregnated with aluminum nitrate is placed in a vacuum high-temperature furnace tube and heated to 800 °C within 1-3 hours under vacuum; argon gas (Ar) with a flow rate greater than 30 sccm is introduced and the temperature is held for more than 3 hours to allow the aluminum oxide coating layer to stably cover the surface of the silicon carbon particle. The final product is the silicon-based anode material of the invention, wherein a thickness of the aluminum oxide coating layer is set between 15 and 20 nanometers to ensure complete coverage of the silicon carbon particle.

In the preparation method of the invention, a carbon source used in the aluminum oxide coating layer may include, but is not limited to asphalt, resin, methane, acetylene, citric acid, maleic anhydride, etc. ; a composition of the aluminum oxide coating layer includes, but is not limited to aluminum oxide, aluminum hydroxide, aluminum sulfate, aluminum phosphate, aluminum tripolyphosphate, aluminum borate, aluminum silicate, etc. In addition, an aluminum oxide coating process includes, but are not limited to liquid phase chemical reaction deposition, chemical vapor deposition (CVD), chemical vapor reaction (CVR), atomic layer epitaxy (ALD), etc.

The silicon-based anode material provided by the invention may be applied in the manufacture of an anode structure of the lithium-ion battery and further in the preparation of the lithium-ion battery. The silicon-based anode material further enhances the interfacial stability and high-temperature resistance of the material by optimizing the composition and structural design of the aluminum oxide coating layer, effectively reducing decomposition of the electrolyte and degradation of the SEI layer under high-temperature conditions. In addition, the invention may further significantly improve the rate performance and coulombic efficiency of the silicon-based anode material, enabling the lithium-ion battery to maintain good capacity retention under high-rate charge and discharge conditions, thereby enhancing fast-charging capability and long-term performance.

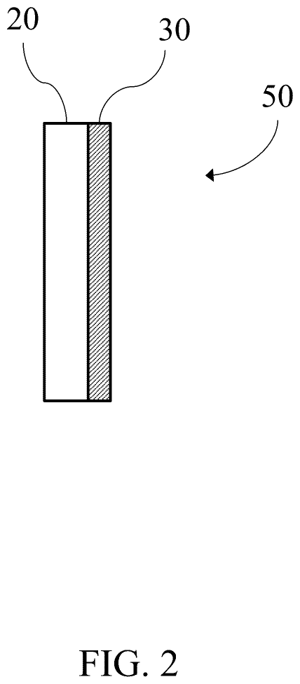

With reference to FIG. 2, a diagram of an anode structure of a lithium-ion battery provided by an embodiment of the invention is shown. The anode structure 50 of the lithium-ion battery of the embodiment includes the above silicon-based anode material 10 (see FIG. 1), an adhesive, a conductive agent (not shown in the figure), and a copper foil 20. The silicon-based anode material 10, the adhesive and the conductive agent are uniformly mixed to form a slurry, which is then uniformly coated on a surface of the copper foil 20. After drying and compaction, an anode material layer 30 with good mechanical strength and electrical conductivity may be formed, further improving the overall performance of the lithium-ion battery.

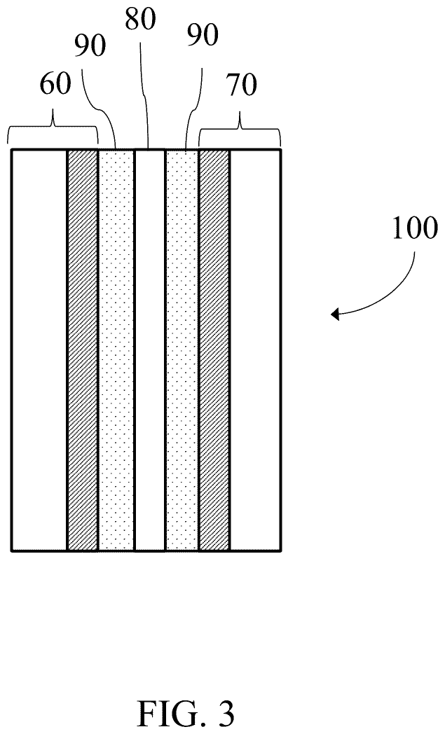

With reference to FIG. 3, a diagram of the lithium-ion battery provided by an embodiment of the invention is shown. The lithium-ion battery 100 of the embodiment includes a cathode 60, an anode 70, a separator film 80 and an electrolyte 90. The anode 70 adopts the above anode structure 50 of the lithium-ion battery (see FIG. 2) and is disposed inside the lithium-ion battery 100 opposite to the cathode 60. The two are separated by a separator film 80 to prevent short circuit. Further, the electrolyte 90 permeates between the cathode 60, the anode 70, and the separator film 80, ensuring that lithium ions may migrate smoothly during charging and discharging to maintain stable electrochemical reactions and excellent charging and discharging efficiency.

Then, the silicon-based anode material and the lithium-ion battery slurry of the invention are analyzed and compared through several experimental methods and comparative examples to verify the technical effects achieved by the invention.

### (1) Raman Spectroscopy for Silicon-Based Anode Material

The silicon-based anode materials in the embodiments and comparative examples of the invention all have the silicon carbon particle, wherein the silicon carbon particle contains SiOₓ (0≤x<1) and carbon, and the median particle size (D50) is between 1 and 15 μm. The main difference between the two is that the silicon carbon particle in the embodiment of the invention is coated with the aluminum oxide coating layer, while the silicon-based anode material in the comparative example does not contain the aluminum oxide coating layer. The experiment uses focused laser light with a wavelength of 532 nm to perform Raman spectroscopy, and uses general Raman spectroscopy methods to collect inelastic scattering signals, and then uses a spectrometer for spectral dispersion.

In the Raman spectra, the related characteristic peaks of aluminum oxide compounds are located in a range of 395-460 cm-1, while the characteristic peaks of silicon are located in a range of 475-530 cm-1. The total signal intensity within each interval is defined as the Raman scattering intensity of the individual compound.

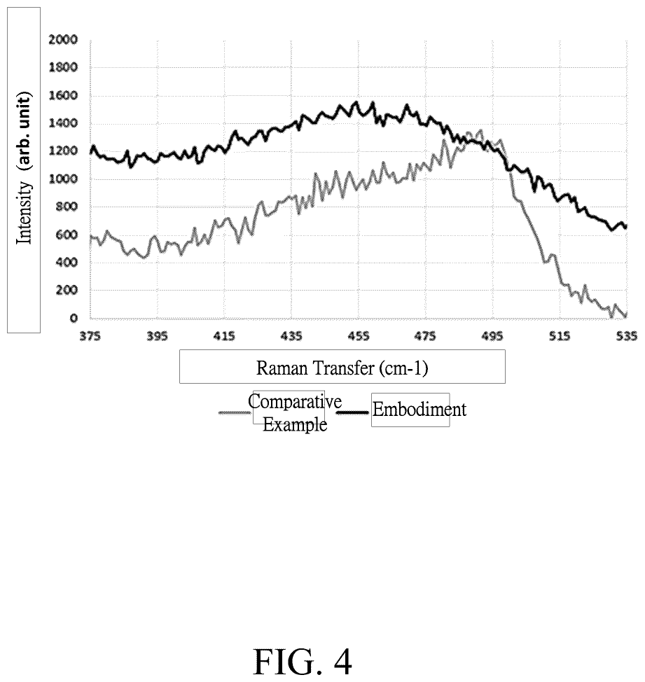

With reference to FIG. 4, the Raman scattering spectra o the silicon-based anode material of an embodiment and a comparative example of the invention is shown. Analysis results show that the Raman scattering intensity ratio of the characteristic peaks of aluminum oxide and silicon in the embodiments of the invention exceeds 1.2%, while that in the comparative example does not exceed, indicating that the aluminum oxide coating layer of the embodiments of the invention uniformly covers the carbon silicon particle, ensuring better structural stability and conductivity.

### (2) XPS Surface Analysis of Silicon-Based Anode Material

The embodiments of the invention is the silicon-based anode material with the aluminum oxide coating layer. The experiment employes conventional XPS (X-ray Photoelectron Spectroscopy) technology, using an aluminum Kα monochromatic X-ray source, to perform surface analysis on the silicon-based anode material of the embodiment; for silicon and aluminum, the total XPS signal intensity between 94-110 eV (silicon) and 65-80 eV (aluminum) is calculated, and defined as the characteristic peak intensity of silicon and aluminum after correction by the relative sensitivity factor (RSF) of each element. Further, the etching is performed using ion sputtering technology, with XPS analysis performed every 7 nm to obtain the depth distribution of the characteristic peak intensities of silicon and aluminum.

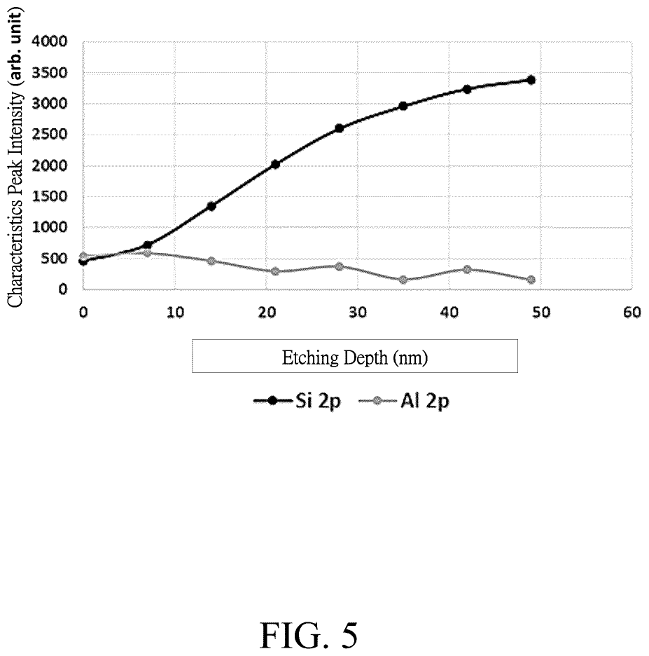

With reference to FIG. 5, the relationship between the intensity of the aluminum characteristic peak and the etching depth obtained by surface XPS analysis for the silicon-based anode material of the invention is shown. Analysis results show that the aluminum characteristic peak intensity of the embodiment of the invention has an inflection point at 15 nm, indicating that the thickness of the aluminum oxide coating layer is about 15 nm. The thickness ensures the electrochemical stability and long-term cycle life of the anode material.

### (3) Analysis on Gas Production in Lithium-Ion Battery Slurry

As mentioned above, the embodiments of the invention are silicon-based anode materials with the aluminum oxide coating layer, while the silicon-based anode materials of Comparative Examples do not contain the aluminum oxide coating layer. A slurry is prepared by uniformly mixing graphite particles, silicon-based anode materials, conductive carbon (including carbon black and carbon nanotubes), and adhesives (including sodium carboxymethyl cellulose (CMC) and styrene-butadiene rubber (SBR)) in deionized water. The proportions of the components in the slurry are graphite: silicon-based anode material: conductive carbon:CMC:SBR=83:13:1: 1.2:1.8.

After the slurry is placed in an aluminum-plastic bag and sealed, the volume change of the aluminum-plastic bag is recorded using the Archimedes method, and the daily volume change is recorded to define the gas production.

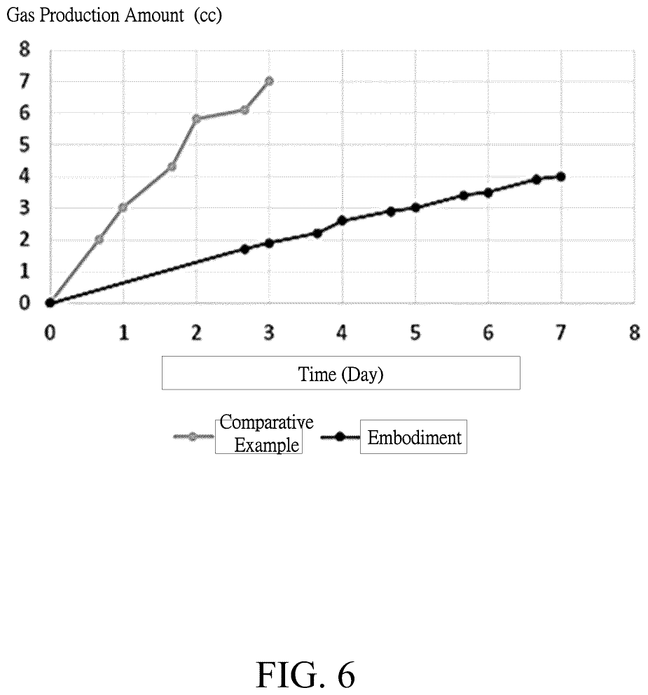

With reference to FIG. 6, the relationship of changes in gas production over time of a slurry prepared from the silicon-based anode material in an embodiment and a comparative example of the invention is shown. Analysis results show that the gas production in the embodiments of the invention is much lower than that in Comparative Examples, indicating that the invention may effectively improve the coating completion of the silicon-based anode material, reduce the gas formed by the side reaction between the exposed silicon surface and trace moisture, and thus improve the cycle life and safety of the battery.

In summary, the silicon-based anode material provided by the invention is provided with an aluminum oxide coating layer, which may significantly improve the overall performance of the lithium-ion battery. The core of the silicon-based anode material is the silicon carbon particle, with an outer layer coated with the aluminum oxide coating layer. This design improves conductivity and stability, while effectively reducing the volume expansion of the silicon-based material during charging and discharging, thereby extending the lifespan of the lithium-ion battery. The aluminum oxide coating layer may further improve the cycle stability of lithium-ion batteries and reduce battery degradation under high temperature conditions.

The silicon-based anode material of the invention may be applied to the anode structure of the lithium-ion battery, and further improves the fast charging performance and long-term use efficiency of the lithium-ion battery. Compared with traditional silicon-based materials, the design of the aluminum oxide coating layer may significantly improve the stability of the material, especially in high-temperature environments, which may effectively suppress the formation of unnecessary SEI layers, thereby improving the cycle life and fast charging capability of lithium-ion batteries.

Through multiple experimental analyses and comparisons, the silicon-based anode material of the invention exhibits superior cycle life under high-temperature conditions, demonstrating a potential for wide application in lithium-ion batteries. The technical breakthrough in the silicon-based anode material provides an effective solution for improving the performance of lithium-ion batteries, and has significant technical implications for enhancing battery stability, fast charging capability, and long-term performance.

Although the invention has been described in detail through the above preferred embodiments, it should be understood that the above description should not be considered as a limitation of the invention. After reading the above, those skilled in the art will find that various modifications and substitutions to the invention will be readily apparent. Therefore, the scope of protection of the invention should be defined by the appended claims.

What is claimed is:

1. A silicon-based anode material, comprising:
a non-metal-doped silicon carbon particle, composed of a mixture of SiOₓ and carbon, where 0≤x<1; and
an aluminum oxide coating layer, coated onto a surface of the silicon carbon particle;
wherein in the Raman spectrum of the silicon-based anode material, a ratio of characteristic peak areas of aluminum oxide to that of silicon is greater than 1.2%.

2. The silicon-based anode material according to claim 1, wherein a median particle size (D50) of the silicon carbon particle is between 1 and 15 micrometers.

3. The silicon-based anode material according to claim 1, wherein a composition of the aluminum oxide coating layer comprises one or more of aluminum oxide, aluminum hydroxide, aluminum sulfate, aluminum phosphate, aluminum tripolyphosphate, aluminum borate, and aluminum silicate.

4. A lithium-ion battery anode structure, comprising a silicon-based anode material, an adhesive, a conductive agent, and a copper foil, wherein the silicon-based anode material, the adhesive, and the conductive agent are uniformly mixed to form a slurry, which is then coated onto a surface of the copper foil and dried and compacted to form a stable anode material layer, wherein the silicon-based anode material comprises:
a non-metal-doped silicon carbon particle, composed of a mixture of SiOₓ and carbon, where 0≤x<1; and
an aluminum oxide coating layer, coated onto a surface of the silicon carbon particle;
wherein in the Raman spectrum of the silicon-based anode material, a ratio of characteristic peak areas of aluminum oxide to that of silicon is greater than 1.2%.

5. The lithium-ion battery anode structure according to claim 4, wherein a median particle size (D50) of the silicon carbon particle is between 1 and 15 micrometers.

6. The lithium-ion battery anode structure according to claim 4, wherein a composition of the aluminum oxide coating layer comprises one or more of aluminum oxide, aluminum hydroxide, aluminum sulfate, aluminum phosphate, aluminum tripolyphosphate, aluminum borate, and aluminum silicate.

7. A lithium-ion battery, comprising a cathode, an anode, a separator film, and an electrolyte, wherein the anode adopts the lithium-ion battery anode structure according to claim 4, the cathode and the anode are respectively disposed inside the lithium-ion battery and separated from each other by the separator film, and the electrolyte is immersed among the cathode, the anode and the separator film.
